(19) United States
(12) Patent Application Publication
(10) Pub. No.: US 2004/0250288 A1
(43) Pub. Date: Dec. 9, 2004

(54) Method and apparatus for storing surveillance films

(76) Inventor: Robert R. Palmerio, Lyndhurst, OH (US)

Correspondence Address: James A. Hudak, Esq., Suite # 304, 29425 Chagrin Blvd.,, Cleveland, OH, 44122-4602, US

(21) Appl. No.: 10/454,244

(22) Filed: Jun. 5, 2003

(51) Int. Cl. H04N 7/12

(52) U.S. Cl. 725/105; 375/240.01

(57) ABSTRACT

A unique method and apparatus for remotely storing digital video surveillance films and the accessing of same are disclosed. The method and apparatus is comprised of a plurality of video surveillance cameras connectable to one or more satellite video processors which are connectable to the Internet. One or more remote personal computers and a remote disc array video storage device are also connectable to the Internet. The cameras take video images which are compressed by the satellite video processor and transmitted to the remote disc array video storage, via the Internet. A person at a remote personal computer can access the images being taken by the cameras, via the Internet, in “real-time” and can also access the images that are stored in the remote disc array video storage. The result is a system that provides the same performance as a system utilizing an expensive digital video recorder installed at each camera location, thus greatly reducing equipment and maintenance costs. Additionally, the remotely stored video images are secured and cannot be manipulated or altered. Therefore, authenticated, unedited video images are provided using this method.

### TECHNICAL FIELD

The present invention relates, in general, to the storage of digital video surveillance films, and, more particularly, to a method and apparatus for remotely storing digital video surveillance films and the accessing of same.

### BACKGROUND ART

New technologies are being made available through the use of telephone communications, private computer networks and the Internet. One example of how technology has recently encouraged growth in a particular field is video surveillance. The costs associated with monitoring a particular location or premises has been greatly reduced through video surveillance. A business can successfully monitor an entire building using only one security guard who monitors multiple video camera recorders installed at key locations throughout a building and/or around the perimeter of same. In addition, one security guard can monitor multiple buildings from remote locations using networking and other available technologies. In some instances, video camera recorders and electronic sensors can be installed to eliminate the need for a security guard. An alarm system can be actuated when an electronic sensor detects the presence of an intruder and the video camera recorders can record and transmit images that can be provided to the police for subsequent apprehension of the intruder.

The use of recorded video for evidentiary purposes has also become a significant crime fighting tool for businesses having numerous scattered installations or operations, such as banks, service stations and retail stores. Despite the success of video surveillance in these instances, equipment maintenance is usually insufficient since qualified technicians are not available at every location. Also, since the recorded video is stored at each location, it is not readily available to the loss prevention or security manager who usually works “off-site” at the headquarters of the business.

In addition to the foregoing, there is the matter of video tape management. In a typical video surveillance system, a plurality of surveillance cameras are inputted into a multiplexer whose output is inputted into a time lapse video camera recorder. The cameras take “still” images which are recorded on video tape in the video camera recorder. After use, the tapes are removed from the video camera recorder and placed in a tape storage. After a period of time, the tapes within the tape storage are erased and reused. The video tapes are typically stored “on-site” and are not readily accessible from a remote location. In addition, the quality of the images on the tapes decreases over time due to tape wear.

Alternatively, the plurality of surveillance cameras can be inputted into a digital recorder having a hard drive storage therein. One or more remote personal computers can access the cameras connected to the digital reorder, via the Internet, so as to be able to view the images being taken by the cameras in “real-time”. In this case, the images being taken by the cameras are stored “on-site” in the hard drive storage within the digital recorder and can be viewed at the digital recorder or at a remote personal computer. A significant disadvantage of this system is that the digital recorder is a very costly device. In addition, since a digital recorder is actually a computer, operation and maintenance of the recorder requires computer skills.

In view of the foregoing, it has become desirable to develop an inexpensive method and relatively maintenance-free method and apparatus for capturing surveillance video from a plurality of cameras and automatically transferring the video files, via the Internet, to a remote computer for storage and subsequent accessing purposes.

### SUMMARY OF THE INVENTION

The present invention solves the problems associated with the prior art approaches of taking and storing digital video surveillance films through the use of video camera recorders, and other problems, by providing a novel method and apparatus for the storing of digital video surveillance films and the accessing of same. The method and apparatus of the present invention is comprised of a plurality of video surveillance cameras connectable to the inputs of one or more satellite video processors whose outputs are connectable to the Internet. One or more remote personal computers and a remote disc array video storage device are also connectable to the Internet. The cameras take video images which are captured, compressed and transmitted in an unedited format to the remote disc array video storage device, via the Internet. A person at a remote personal computer can access the images being taken by the cameras, via the Internet, in “real-time” and can also access the images that are stored in the remote disc array video storage device. In this manner, video recorder maintenance is eliminated, the number of cameras that can be utilized is almost limitless, a costly digital recorder with an integral hard drive is not required and the video storage device is “off-site”.

### BRIEF DESCRIPTION OF THE DRAWINGS

FIG. 1 is a schematic diagram of a prior art system for taking and storing analog video surveillance films.

FIG. 2 is a schematic diagram of a prior art system for taking and storing digital video surveillance films.

FIG. 3 is a schematic diagram of the present invention illustrating the system utilized required for taking and storing digital video surveillance films.

FIG. 4 is a schematic diagram of the satellite video processor used to capture, process and transmit video surveillance films.

FIG. 5 is a schematic diagram of a more fully developed system for taking and storing digital video surveillance films utilizing the present invention illustrated in FIG. 3.

### DESCRIPTION OF THE PREFERRED EMBODIMENT

Referring now to the Figures where the illustrations are for the purpose of describing the preferred embodiment of the present invention and are not intended to limit the invention described herein, FIG. 1 is a schematic diagram illustrating a prior art system for taking and storing analog video surveillance films. In this Figure, the outputs of up to sixteen (16) video surveillance cameras 10 are inputted into a multiplexer 12 whose output is inputted into a time lapse video camera recorder 14. The cameras 10 take “still” images which are recorded on video tape in the video camera recorder 14. After use, the tapes are removed from the video camera recorder 14 and placed in a tape storage 16 which is typically “on-site”. Thus, in this system the tapes are stored “on-site” and video can be viewed in “real-time” or in the stored format at the “on-site” location. After a period of time, the tapes within the tape storage 16 are erased and are reused by the video camera recorder 14.

Referring now to FIG. 2, a schematic diagram of a prior art system for taking and storing digital video surveillance films is illustrated. In this case, the outputs of up to sixteen (16) video surveillance cameras 20 are inputted into one or more digital recorders 22 having a hard drive storage therein and one or more video sending devices 24 containing Internet protocols. The outputs of the digital recorders 22 and the video sending devices 24 are connectable to the Internet 26. One or more remote personal computers 28 are similarly connectable to the Internet 26 permitting a person at a remote personal computer 28 to view the images being taken by the cameras 20 in “real-time”. In this case, the images being taken by the cameras 20 are stored either “on-site” in the hard drive storage within the digital recorder 22 or “off-site” in a digital tape library 30. The disadvantages of this system are that the digital recorder 22 is a very costly device requiring computer skills for maintenance, the images stored in the recorder hard drive are unsecured and can be easily altered, and retrieval of remotely archived video is a slow process due to the nature of digital tape library operations.

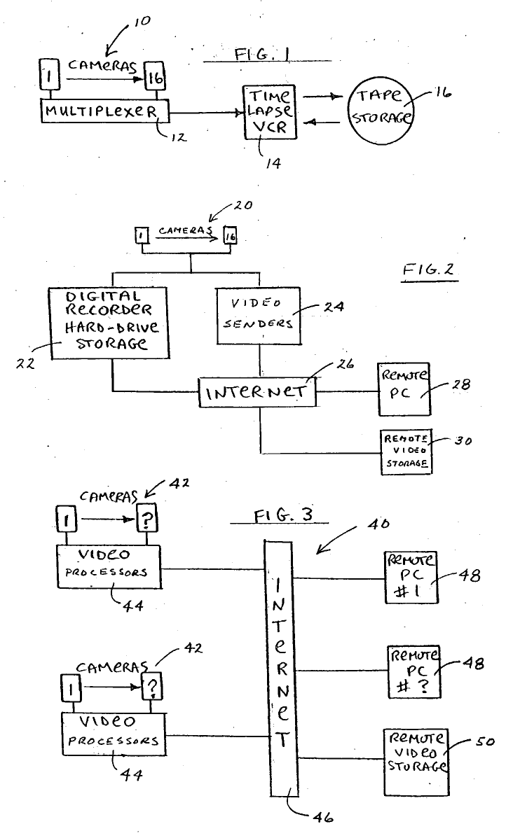

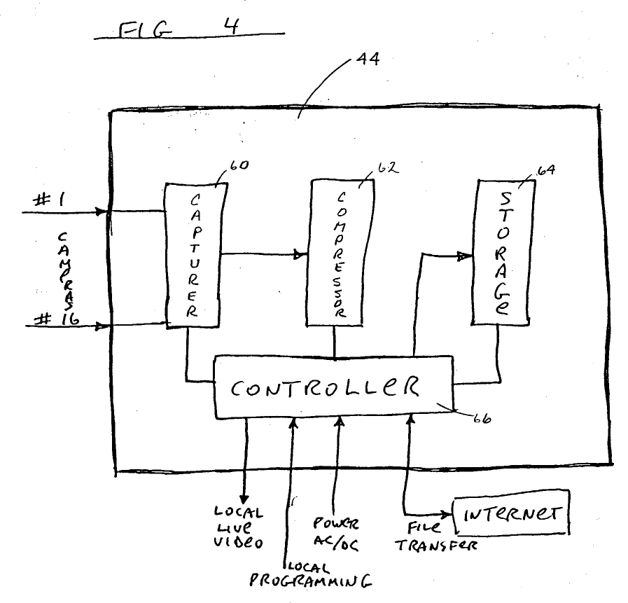

Referring now to FIG. 3, a schematic diagram of the system, referred to generally by the numeral 40, for taking and storing digital video surveillance films of the present invention is illustrated. In this case, the system 40 is comprised of a number of video surveillance cameras 42 connectable to the inputs to one or more satellite video processors 44 whose outputs are connectable to the Internet 46. One or more remote personal computers 48 and a remote video storage device 50 are also connectable to the Internet 46. The cameras 42 take surveillance images which are transmitted in an unedited format, via a satellite video processor 44, over a secured connection to the remote video storage device 50, via the Internet 46. A person at a remote personal computer 48 can view the images being taken by the cameras 42 in “real-time” and can also access the images that are stored in the remote video storage device 50, via the Internet 46. The remote video storage device 50 is typically located “off-site”. Thus, in this system the video files are stored “off-site”, however, video can be viewed in “real-time” either “on-site” or at a remote location and can also be viewed in the stored format at a remote location. The advantages of this system are that local recording equipment is replaced by relatively maintenance-free video processors, the number of cameras that can be utilized is almost limitless, a substantial cost savings is realized since costly digital recorders are not required, the video storage is “off-site”, the stored video is quickly accessed since it is on a hard drive and the stored images are secured and cannot be manipulated or altered.

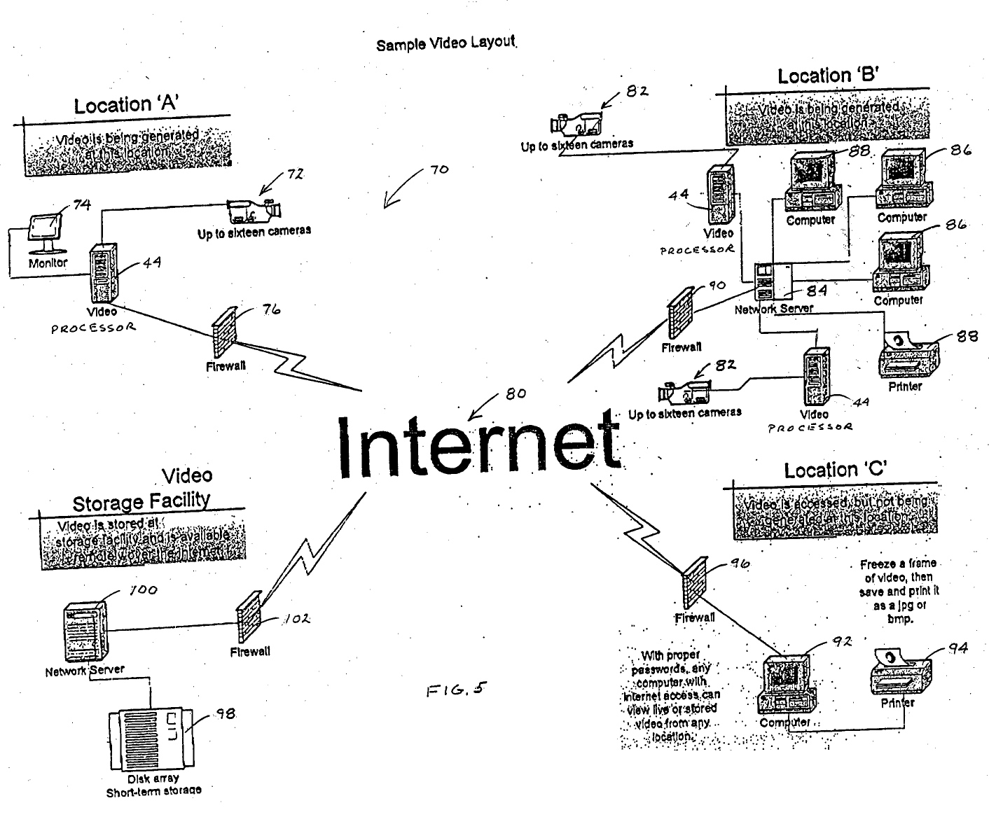

FIG. 4 is a schematic diagram of the satellite video processor 60 used to capture, process and transmit video surveillance films in the present invention. The satellite video processor 44 is comprised of a video capturer 60, a video compressor 62, a video file storage 64 and a controller 66. The satellite video processor 44 is a completely solid state unit having embedded software therein. The outputs of up to sixteen (16 ) video surveillance cameras are connected to the input to the video capturer 60 which includes a high-speed frame grabber that provides both local and remote viewing of live video. The output of the video capturer 60 is connected to the input to the video compressor 62 which provides the desired video compression. In this case, an adjustable compression ratio is also provided. The video file storage 64 includes a flash memory which used for the emergency storage of video films in the event of a communication failure between the satellite video processor 44 and a remote video storage device. The controller 66 transfers video files to a remote video storage device, via the Internet, and has embedded software therein to perform the following functions:

a) System set-up;

b) Camera set-up including contrast, hue, etc.;

c) Motion detection set-up, recording rate, etc.;

d) Live video viewing options; and

e) System clock, start-up, sequencing, etc. The controller 66, in essence, controls the operation of the video capturer 60, the video compressor 62 and the video file storage 64.

Referring now to FIG. 5, a more fully developed system 70 utilizing the remote video storage concept of the present invention is illustrated. In this case, at location “A”, the outputs of up to sixteen (16) video surveillance cameras 72 are connected to the input to a satellite video processor 44 which also has a monitor 74 connected thereto. The output of the satellite video processor 44 is connectable, via a firewall 76, to the Internet 80. At location “B”, the output of each video surveillance camera 82 within each of one or more groups of up to sixteen (16) video surveillance cameras 82 is connected to a satellite video processor 44. The output of each satellite video processor 44 is connected to an input to a network server 84. One or more personal computers 86 are similarly connected to an input to the network server 84. A printer 88 is connected to the output of the network server 84. Another output of the network server 84 is connectable to the Internet 80, via a firewall 90. At location “C”, a personal computer 92 is connected to a printer 94 and is connectable to the Internet 80, via a firewall 96. At the video storage facility, multiple disc arrays 98 are connected to the inputs to a network server 100 which contains file transfer/retrieval software for use with satellite video processors that lack file transfer capabilities. The network server 100 is connectable to the Internet 80, via a firewall 102. As illustrated in this Figure, video images are generated at locations “A” and “B”. Video images can be accessed at location “C”, but are not generated at this location. Video images are stored at the video storage facility in the multiple discs arrays 98 and can be accessed remotely, via the Internet 80, at locations “B” and “C”.

The uniqueness of the present invention is that unedited video images are stored within a remote video storage location and can be quickly downloaded and viewed, via the Internet, through the use of a personal computer at any one of a number of locations. This “off-site” storage of unaltered video images provides authenticated unedited video evidence that cannot be manipulated or altered and which may be used in a court of law. The use of a remote storage video location eliminates the need for video storage “on-site” and the costs associated with same and/or the costs of a digital recorder. In addition, the present invention permits the video images to be viewed in “real-time” at the location where the images are being generated or at a remote location. Thus, the present invention overcomes the problems associated with prior art systems for taking and storing digital video surveillance films by eliminating the need for “on-site” storage of such films and/or the use of a digital recorder and provides an inexpensive method and apparatus for taking digital video surveillance films, storing the video images at a remote video storage location and readily accessing the video images at a personal computer, via the Internet.

Certain modifications and improvements will occur to those skilled in the art upon reading the foregoing. It is understood that all such modifications and improvements have been deleted herein for the sake of conciseness and readability, but are properly within the scope of the following claims.

I claim:

1) A video processor for capturing, compressing, storing and transmitting video images from one or more video cameras comprising means for capturing the video images from the one or more video cameras, means for compressing said video images captured by said capturing means, means for storing said video images compressed by said compressing means, means for transmitting said video images compressed by said compressing means, and means for controlling the operation of said capturing means, said compressing means, said storing means and said transmitting means.

2) A multi-access remote video surveillance system comprising one or more groups of video surveillance cameras, a video processor operably connected to each of said one or more groups of video surveillance cameras, communications linking means operably connected to said video processor, one or more remote video storage devices operably connected to said communications linking means, and one or more remote personal computers operably connected to said communications linking means, said video processor and said one or more remote video storage devices being accessible by said one or more personal computers via said communications linking means.

3) The multi-access remote video surveillance system as defined in claim 2 further including a network serving device interposed between and operably connected to said video processor and said communications linking means.

4) The multi-access remote video surveillance system as defined in claim 3 wherein said network serving device is interposed between and operably connected to said one or more remote personal computers and said communications linking means.

5) The multi-access remote video surveillance system as defined in claim 3 further including firewall protection means, said firewall protection means being interposed between said network serving device and said communications linking means.

6) The multi-access remote video surveillance system as defined in claim 3 further including a printing device operably connected to said network serving device.

7) The multi-access remote video surveillance system as defined in claim 2 wherein said one or more remote video storage devices includes a network serving device having file transfer/retrieval capabilities and a disc array storage device operably connected to said network serving device.

8) The multi-access remote video surveillance system as defined in claim 7 further including firewall protection means interposed between said network serving device and said communications linking means.

9) The multi-access remote video surveillance system as defined in claim 2 further including firewall protection means interposed between said one or more remote personal computers and said communications linking means.

10) The multi-access remote video surveillance system as defined in claim 9 further including a printing device operably connected to said one or more remote personal computers.
